(19) United States
(12) Patent Application Publication
(10) Pub. No.: US 2005/0171304 A1
(43) Pub. Date: Aug. 4, 2005

(54) Method for quantitative characterization of polymerization catalyst performance

(76) Inventor: Peter Chen, Zollikerberg (CH)

Correspondence Address: GREENLEE WINNER AND SULLIVAN P C, 4875 PEARL EAST CIRCLE, SUITE 200, BOULDER, CO, 80301, US

(21) Appl. No.: 10/455,751

(22) Filed: Jun. 4, 2003

Related U.S. Application Data
(60) Provisional application No. 60/386,082, filed on Jun. 4, 2002.

(51) Int. Cl. C08F 2/00

(52) U.S. Cl. 526/61; 526/160

(57) ABSTRACT

The present invention provides methods for assessing the performance of one or more test olefin polymerization catalysts which comprise one or more metals. The methods are based on the use of coordinating-reactive quencher molecules that are added to polymerization reactions to tag oligomers and optionally to tag polymers that were bound to active catalyst at the time of quenching. The tag allows the identification and analysis of the molecular weight, length, and structure of oligomers and polymers generated by the activated catalyst as a function of reaction time as well as other polymerization process parameters. Evaluation of the presence or absence of tagged oligomers and polymers, the relative molecular weights, lengths and/or structure of the tagged oligomers and polymers and/or the determination of the relative or absolute amounts of tagged oligomer and polymers generated on quenching provide information which can be used to assess the performance of one or more activated polymerization catalyst.

### CROSS-REFERENCE TO RELATED APPLICATIONS

This application claims the benefit of U.S. Provisional Application No. 60/386,082 filed Jun. 4, 2002, which is incorporated herein by reference in its entirety.

### BACKGROUND OF THE INVENTION

Polymerization of olefins with transition metal catalysts is the basis for almost 100 million metric tons of production of polyolefins. Since 1991, the introduction of single-site catalysts (SSC) has led to a rapid and substantial improvement in the production of polyolefins that are nevertheless still manufactured from inexpensive monomers. Single-site catalysts offer the possibility of fine control over polymer microstructure, monomer selectivity, and molecular weight distributions. The fraction of polyolefins produced with single-site catalysts is currently 10% and increasing. Nevertheless, the testing, evaluation, and understanding of SSC's is greatly hampered by technical constraints imposed by the chemistry of the catalysts.

Conventional testing of a catalyst relies on the characterization, not of the catalyst itself, but rather of the product(s) of catalysis, i.e. the polymer produced. Bulk polymerization reactions and analysis are time-consuming and require large amounts of material-typically 100 grams of catalyst when a full characterization with multiple runs is required. Moreover, the information derived is relatively coarse in that the various effects of catalyst structure, activation, and process parameters are not cleanly separated, limiting the predictive value of the data. Every experiment is a special case. Experiments with SSC's are particularly difficult because the actual compound that is handled by the chemist is not the active catalyst itself, but more properly a procatalyst which is transformed in situ into the active species by an activation process. The active catalytic species, usually exceedingly labile, can not typically be observed. As a result, product analysis has been used to assess catalyst performance in such polymerization reactions, despite its inherent limitations.

Conventional catalyst testing based on product analysis provides little or no information on certain parameters that would be useful for SSC catalyst evaluation. For example, conventional methods do not provide information on the concentration of active catalytic species for a given concentration of catalyst under a particular set of activation conditions. Conventional methods do not allow determination of the relative rates for activation, propagation, and chain transfer for any given combinations of catalyst, activator, and process conditions. There is a need in the art for catalyst evaluation methods that will provide information useful for predicting product properties over a wide range of combinations of catalyst, activator and process conditions, and particularly for methods that are not time-consuming and costly to perform. Further, there is a need in the art for catalyst evaluation methods that can be rapidly applied to wide variations in the composition, structure and form of catalysts, to variations in catalyst supports and catalyst activators, and to variations in temperature, pressure, monomer concentrations, solvent and other polymerization reaction conditions to facilitate the optimization of a given polymerization reaction for a given monomer or to optimized conditions and catalyst to achieve a desired product outcome.

The present invention provides novel methods for providing information useful for the evaluation of metal-containing catalysts which can be employed to select and design new catalysts, to select and design new catalyst activators, to select and design process conditions and to facilitate the optimization of polymerization reactions. These methods are particularly useful for evaluation of SSC.

### SUMMARY OF THE INVENTION

The present invention provides methods for assessing the performance of one or more test olefin polymerization catalysts which comprise one or more metals. In a specific embodiment, the methods are based on the use of coordinating-reactive quencher molecules that are added to polymerization reactions to tag oligomers and optionally to tag polymers that were bound to active catalyst at the time of quenching. The tag allows the identification and analysis of the molecular weight, length, and structure of oligomers and polymers generated by the activated catalyst as a function of reaction time as well as other polymerization process parameters. Evaluation of the presence or absence of tagged oligomers and polymers, the relative molecular weights, lengths and/or structure of the tagged oligomers and polymers and/or the determination of the relative or absolute amounts of tagged oligomer and polymers generated on quenching provide information which can be used to assess the performance of one or more activated polymerization catalysts. In particular, the determination of molecular weight distribution of the tagged oligomers and polymers generated on quenching of the polymerization reaction can be used to calculate kinetic parameters such as the rates of initiation, propagation and chain-transfer for the polymerization using a selected catalyst, selected activator (if needed) and selected process conditions. By determining rates at several representative values of temperature, monomer concentration, or other process parameters, Arrhenius activation parameters for initiation, propagation, and chain-transfer of the polymerization reaction can be obtained to in turn obtain kinetic expressions that model a given polymerization reaction. Rates at other values of process parameters can then be computed (rather than measured), and put into the kinetic expressions. This allows the computation of monomer uptake rate as well as the molecular weight distribution of metal-free polymer product. When the methods are practiced using quenching at short time when all oligomers are still soluble, the method allows prediction of polymer properties without actually producing any polymer.

The methods of this invention can be used simply to detect whether or not a given metal-containing polymerization catalyst is active for polymerization of a selected olefin monomer, optionally in the presence of a selected activator, under selected reaction conditions. As such, the methods of this invention can be employed to screen one or more catalysts, including a library of catalysts which, for example, span a range of chemical structures, for activity or improved activity for polymerization of one or more selected olefins. The methods of this invention can also be employed to screen one or more activator molecules, including a library of such activators which, for example, span a range of chemical structures, for activity or improved activity for activation of a given polymerization catalyst for polymerization of one or more selected olefins. Further, the methods of this invention can be employed to screen for optimization of any one or more polymerization reaction conditions or parameters, including among others, reaction temperature, reaction time, monomer concentration, pressure, solvent, or catalyst support.

More specifically the invention provides a method for evaluation of the activity and/or performance of a metal-containing catalyst, particularly an organometallic catalyst, which comprises the steps of:
(a) contacting the activated test polymerization catalyst with one or more polymerizable olefins under a selected set of reaction conditions for a selected reaction time;
(b) quenching the polymerization reaction at that selected reaction time with a coordinating-reactive quencher reagent which generates tagged oligomers and optionally tagged polymers on quenching wherein the oligomers and any polymers that are tagged are those oligomers and polymers that at the time of quenching were bound to the catalyst;
(c) detecting any tagged oligomers and tagged polymers generated on quenching; and
(d) assessing the performance of the activated test polymerization catalyst based on the tagged oligomers and tagged polymers detected.

The tagged oligomers and tagged polymers may be detected by any means known to the art, including mass spectrometry.

Assessment of the performance of the activated test polymerization catalyst “based on the tagged oligomers and tagged polymers detected”, includes, but is not limited to, assessment made considering the detection of the tagged oligomers and tagged polymers alone, assessment made considering detection and further analysis of the tagged oligomers and tagged polymers, and assessment made considering detection of the tagged oligomers and tagged polymers combined with detection of an internal standard.

In a specific embodiment, whether the catalyst is active for polymerization of a selected olefin may be assessed by determining whether any tagged oligomers and tagged polymers can be detected.

In a specific embodiment any tagged oligomers and polymers generated on quenching are analyzed by mass spectrometric methods to determine the molecular weights of these tagged products, the molecular weight distribution of tagged products, the relative product distribution, or other structural properties of the tagged products. In a preferred embodiment, the tagged products are analyzed by electrospray ionization mass spectrometry. Ions can be generated by a variety of ionization methods known in the art. Further, the ionization method chosen preferably does not invalidate the selection criteria, e.g., in polymerization catalyst screening, the ionization method employed does not itself substantially affect ion polymer chain length. Determination of the molecular weights of these tagged products, the molecular weight distribution of tagged products, the relative product distribution, or other structural properties of the tagged products allows assessment of the performance of the activated test polymerization catalyst.

In another specific embodiment, the absolute amounts of tagged oligomers, tagged polymers and/or the total absolute amount of tagged oligomers and any tagged polymers formed on quenching can be determined by the methods of this invention. Quantitation of tagged oligomers requires the addition of an internal standard to each sample that is to be quantified. In a preferred embodiment, a cationic or anionic dye is employed as an internal standard. A specific cationic dye useful as an internal standard in the methods herein is Rhodamine 6G. Determination of the absolute amounts of tagged oligomers, tagged polymers and/or the total absolute amount of tagged oligomers and any tagged polymers formed on quenching allows assessment of the performance of the activated test polymerization catalyst.

In general the methods of this invention are useful in evaluation of the performance of various metal-containing olefin polymerization catalysts. The methods are particularly useful for the evaluation of SSC. The catalysts tested or evaluated (which may be charged or neutral species) can include, among others, organometallic complexes, metallocenes, and metal complexes with one or more bidentate ligands. The test catalyst may be a new compound or complex whose catalytic activity is as yet undiscovered or which is a catalyst that is known to be active for olefin polymerization. The methods herein are useful for the evaluation and assessment of homogeneous catalysts and heterogeneous catalysts, including supported catalysts.

In a specific embodiment of the methods of the present invention, an activated polymerization catalyst which contains at least one metal is contacted with an olefin (e.g., an alkene (such as ethylene), a styrene, a norbornene, a cyclopentene, or a substituted olefin, such as an olefin carrying one or more polar functional groups), typically in a selected solvent, and allowed to react for a selected time, preferably a short time such that the products formed are substantially soluble oligomers rather than insoluble polymers. The activated catalyst may be generated by contacting a catalyst (or procatalyst) with an activator, such as methylalumoxane (MAO) or a modified MAO. Reaction is stopped at the selected reaction time by addition of the quenching reagent. The quenching reagent reacts with the metal-carbon bond of the metal-bound oligomer or polymer chain to form a chain, optionally also metal-bound, that tags those chains as having been bound on the metal center at the time of quenching. Preferred quencher molecules are those that are readily ionized to facilitate mass spectrometric analysis.

The methods of the invention also include a method for quantification of the amount of active species of a metal-containing catalyst for a given amount of activator. This method is useful for catalysts activated by MAO or modified MAO such as metallocene catalysts. Without wishing to be bound by any particular theory, it is believed that upon activation with MAO the catalyst forms a methylated catalyst species. If an appropriate quencher is then reacted with an activated catalyst, the methyl group is then transferred to the quencher. In a specific embodiment, the reaction between the quencher and the activated catalyst is conducted in the absence of a polymerizable olefin. Comparison of the number of transferred methyl groups to the amount of unreacted quencher allows quantification of the amount of active metallocene catalyst (e.g. the percent of quencher methylated). The amounts of reacted and unreacted quencher can be determined using mass spectrometry, particularly ESI-MS.

More specifically, the invention provides a method for quantification of the amount of active species of a metal-containing catalyst, particularly an organometallic catalyst, comprising the steps of:
(a) activating the metal-containing catalyst with an activator;
(b) reacting the activated catalyst with a coordinating-reacting quencher reagent;
(c) detecting the reacted quencher reagent and any unreacted quencher reagent; and
(d) quantifying the amount of active species of the catalyst by comparing the amount of reacted quencher reagent to the amount of unreacted quencher reagent.

The reacted and unreacted quencher reagent may be detected by any means known the art, including mass spectrometry.

### BRIEF DESCRIPTION OF THE FIGURES

FIG. 1 is a representative mass spectrum of tagged oligomers from a quenched olefin polymerization reaction showing a fit of kinetic parameters to the product distribution.

FIG. 2 is an ESI-MS of a DCC-quenched polymerization of ethylene by MAO activated Cp₂ZrCl₂ after acidic workup. The odd- and even-chain distributions are clearly seen.

FIG. 3 shows the ESI-MS of a DCC quenched polymerization of ethylene by a MAO-activated Fe-based catalyst after acidic workup. The odd- and even-chain distributions are clearly seen.

FIG. 4 shows the percentage of methylated quencher molecules as a function of the number of equivalents of MAO for three different Zr-based metallocene catalysts.

### DETAILED DESCRIPTION OF THE INVENTION

Kinetic parameters for a polymerization reaction can be extracted from metal-bound oligomer distributions measured in quenched reactions. See PCT application IB/00/00062, WO publication 00/43771 and U.S. patent application Ser. No. 09/489,863, filed Jan. 24, 2000, hereby incorporated by reference to the extent not inconsistent with the disclosure herein. In these references, exemplified using palladium catalysts, neutral two-electron donors were used as quenchers and product analysis, e.g., by mass spectrometry, provided a means for screening catalysts for activity and improved performance. The methods described, however, require that the metal-carbon bond in the quenched catalysts is sufficiently stable that metal-bound oligomers can be detected and analyzed. Further, the methods could be used to evaluate homogeneous catalysts.

In a specific embodiment, the present invention facilitates application of this kinetic approach by providing information on product (oligomer and optionally polymer) molecular weights and product distributions where oligomer and polymer products of polymerization are tagged during quenching using a coordinating-reactive quencher. Analysis of the tagged oligomers and polymers provides equivalent information to that available previously for metal-bound oligomer chains. The tag in the present invention is a functional group that is transferred only to metal-bound oligomers or polymers through a chemical reaction. The tag, or a product derived from it, is detectable and identifies those oligomers and polymers that were bound to active catalyst at the time of quenching. In a preferred embodiment, the tag is either ionic or easily ionizable (either cationic or anionic) so that the tagged chains can be analyzed by mass spectrometry and particularly by electrospray ionization mass spectrometry. The tagged products can be analyzed to determine product distributions that can be fit to the kinetic model as described previously to calculate kinetic parameters useful for prediction of catalyst performance.

The polymerization catalysts that can be evaluated by the methods of this invention contain at least one metal to which the quencher molecules of this invention can coordinate. In principle, any metal capable of such coordination that does not adversely effect catalysis can be in the catalyst. Preferably the metal facilitates catalysis of the olefin polymerization reaction. Preferred metals are transition metals. In general, a polymerization catalyst of this invention can contain more than one metal, but the methods herein are particularly useful for evaluation of single-site catalysts. Transition metal polymerization catalysts that can be evaluated by the methods herein include metallocenes, particularly those containing titanium and zirconium, those that contain late transition metals that are those to the right in the periodic table and include iron, cobalt, nickel and palladium. The methods herein are particularly useful for evaluation of SSC's.

Single-site catalysts include those built around early transition metals, typically, titanium and zirconium with a d⁰ electronic configuration, e.g., metallocenes. SSC's also include those based on late transition metals, such as nickel. An overview of Ziegler-Natta polymerization can be found in Fink G., Mulhaupt R., Brintzinger, H. H. (eds). Ziegler Catalysts (1995) Springer-Verlag, Berlin. An analysis of the cost of olefin polymerization is provided by Brockmeier, N. F. (1998) “Polypropylene Reinvented-Cost of Using Metallocene Catalysts,” in Metallocene-Catalyzed Polymers (Benedikt, G. M, Goodall, B. L., eds) Plastic Design Library (New York), p. 11-20. More details of SSC catalysts are provided in L. K. Johnson, C. M. Killian, S. D. Arthur, J. Feldman, E. F. McCord, S. J. McLain, K. Kreutzer, A. M. A. Bennett, E. B. Coughlin, S. D. Ittel, A. Parthasarthy, D. J. Tempel, M. S. Brookhart, PCT Patent Application WO 96/23010, Aug. 1, 1996; S. J. McLain, A. M. A. Bennett, E. B. Coughlin, D. S. Donald, L. T. J. Nelson, A. Parthasarathy, X. Shen, W. Tam, Y. Wang, PCT Patent Application WO 97/02298, Jan. 23, 1997; L. K. Johnson, A. M. A. Bennett, S. D. Ittel, L. Wang, E. Hauptman, R. D. Simpson, J. Feldman, E. B. Coughlin, PCT Patent Application WO 98/30609, Jul. 16, 1998; L. K. Johnson, C. M. Killian, M. Brookhart, J. Am. Chem. Soc. 1995, 117, 6414; L. K. Johnson, S. Mecking, M. Brookhart, J. Am. Chem. Soc. 1996, 118, 267; C. M. Killian, D. J. Tempel, L. K. Johnson, M. Brookhart, J. Am. Chem. Soc. 1996, 118, 11664; B. L. Small, M. Brookhart, A. M. A. Bennett, J. Am. Chem. Soc. 1998, 120, 4049; B. L. Small, M. Brookhart, Organometallics 1999, 32, 2120; S. A. Svejda, L. K. Johnson, M. Brookhart, J. Am. Chem. Soc. 1999, 121, 10634. G. J. P. Britovsek, V. C. Gibson, B. S. Kimberley, P. J. Maddox, S. J. McTavish, G. A. Solan, A. J. P. White, D. J. Williams, J. Chem. Soc. Chem. Comm. 1998, 849; D. A. Bansleben, S. K. Friedrich, T. R. Younkin, R. H. Grubbs, C. Wang, R. T. Li, PCT Patent Application WO 98/42664, Oct. 1, 1998; C. Wang, S. Friedrich, T. R. Younkin, R. T. Li, R. H. Grubbs, D. A. Bansleben, M. W. Day, Organometallics 1998, 17, 3149; T. R. Younkin, E. F. Connor, J. I. Henderson, S. K. Friedrich, R. H. Grubbs, D. A. Bansleben, Science 2000, 287, 460; S. Y. Desjardins, K. J. Cavell, J. L. Hoare, B. W. Skelton, A. N. Sobolev, A. H. White, W. Keim, J. Organomet. Chem. 1997, 544, 163; K. A. Ostoja-Starzewski, J. Witte, Angew. Chem. 1987, 99, 76; A. Held, F. M. Bauers, S. Mecking, Chem. Comm. 2000, 301; F. M. Bauers, S. Mecking, Macromolecules 2001, 34, 1165; F. M. Bauers, S. Mecking, Angew. Chem. Int. Ed. Engl. 2001, 40, 3020. A. Tomov, J. P. Broyer, R. Spitz, Macromol. Symp. 2000, 150, 53. These references are incorporated herein in their entirety for their descriptions of SSC's.

The methods herein allow the evaluation and assessment of the performance of olefin polymerization catalysts. The term performance is used broadly herein to encompass any parameter, property, result or product of a polymerization reaction as catalyzed by a particular catalyst and activator (if needed) that one might wish to evaluate or assess for optimization. For example, it may be desirable to evaluate the kinetics of a given polymerization reaction to select catalyst, activator, and reaction conditions that give an optimal rate. Alternatively, if a certain product distribution is desired, catalyst, activator and reaction conditions can be selected to give the desired product distribution. In yet another alternative, it may be desirable to select a catalyst that provides improved reaction, e.g., enhanced rate or enhanced yield, with one or more selected olefin monomers.

The methods of this invention use a quencher that is both coordinative (i.e., coordinates with the metal of the catalyst) and reactive instead of a simple coordinative quencher. The quenching reagents of the invention are capable of generating tagged chains of oligomers.

In a specific embodiment, a “reactive” quencher reacts with the metal-carbon bond of the metal-bound oligomer or polymer chain to form a chain, optionally also metal-bound, that tags those chains as having been bound on the metal center at the time of quenching. The use of such a coordinating-reactive quencher allows selective functionalization (tagging) of only metal-bound oligomer or polymer chains and facilitates subsequent detection of those metal-bound oligomer chains. Preferred quencher molecules provide tags which are either ionic or readily ionized (either cationic or anionic) to facilitate mass spectrometric analysis. The free oligomers or polymers (as opposed to metal-bound oligomers or polymers) are uncharged and therefore not detectable by mass spectrometry.

In another embodiment, a “reactive” quencher reacts with the activated catalyst to transfer a functional group from the activated catalyst to the quencher. For example, in the case of MAO or modified MAO activated catalysts, the quencher inserts into the metal-methyl bond and a methyl group is transferred from the activated catalyst to the quencher.

In a specific embodiment, it is preferred that the quencher not polymerize. In a specific embodiment, it is preferred that the quencher not react with any catalyst activator. In a specific embodiment, the quencher has no acidic proton that can be reacted with an alkyl metal to form an alkane. In a specific embodiment, the quencher forms a bidentate ligand upon reaction. In a specific embodiment, the quencher contains a carbon-carbon double bond that coordinates with the metal of the catalyst. Furthermore, the quencher may combine one or more of these properties. For example, the quencher may form a bidentate ligand upon reaction and have no acidic proton that can be reacted with an alkyl metal to form an alkane.

Several substance classes meet these requirements. Heterocumulenes, X═C═Y, where X and Y are oxygen, nitrogen, or sulfur bearing sufficient hydrocarbyl substituents so as to satisfy the normal valency of the heteroatom are suitable. Upon alkylation by the metal-bound oligomer chains, heterocumulenes form carboxylate, thiocarboxylate, amide, or amidate ligands with the pendant oligomer chains. Allenes react similarly to heterocumulenes with the production of alkylated π-allyl ligands. Carbonyl compounds with no proton on the α-carbon may be used if there is a second coordinating site present in the quencher, e.g. a pyridine moiety, linked to the carbonyl group. Upon reaction, these carbonyl-containing quenchers are converted to alkoxide ligands. Other suitable quenchers include compounds that can be incorporated into the forming polymer chain during the polymerization process to yield alkyl chains which are detectable by mass spectrometry (MS), particularly electrospray ionization MS. Examples of this type of quencher include, among others, enamines, enolethers, enolesters and unsaturated phosphonium salts.

Other suitable quenchers include substituted olefins having a carbon-carbon double bond that can coordinate to the free coordination site of the catalyst metal. In a specific embodiment, the olefins can be substituted with one or more groups which are either ionic or readily ionized (either cationic or anionic) to facilitate mass spectrometric analysis. Suitable substituted olefins include, but are not limited to, 4-Dimethylamino-1-butene.

In specific embodiments, quenchers useful in this invention include those having the formula:
(Rx)ₐ—X═C═Y—(Ry)_{b}
and salts thereof where X and Y, independently of one another, are N, O or S atoms, Rx and Ry, independent of each other and of other Rx and Ry in the molecule, are one or more optionally substituted hydrocarbyl groups, and any two or more Rx or Ry can be linked together to form a cyclic moiety, a and b are zero, 1 or 2 and represent the number of Rx or Ry groups present to satisfy valency of X or Y and either or both of X and Y can carry a positive or negative charge.

In specific embodiments, suitable quenchers include those in which:
X and Y are both nitrogen (N);
   both of Rx and Ry are optionally substituted alkyl groups;
   one or both of Rx and Ry are cyclohexyl groups;
   the quencher is a carbodiimide.

In a preferred embodiment the quencher is DCC.

In another specific embodiment suitable quenchers are molecules having the formula:
(Rx)ₐX—CR¹═CR²—Y(Ry)_{b}
or salts thereof where X and Y, independently of one another, are N, O or S atoms, Rx and Ry, independent of each other and of other Rx and Ry in the molecule, are one or more optionally substituted hydrocarbyl groups and any two Rx or Ry groups can be linked together to for a cyclic moiety, a and b are zero, 1 or 2 representing the number of Rx or Ry groups present to satisfy valency of X or Y one or both of which may carry a positive or negative charge and R¹ and R², independent of each other, are H or an optionally substituted hydrocarbyl group.

In specific embodiments quenchers include those of the above formula in which
X is N and Y is O;
Y is O and R² is an optionally substituted aryl group;
Y is O and R² is an optionally substituted aryl group;
X is N and Rx and R¹ together form an optionally substituted aryl group;
the quencher is an optionally substituted 2-benzoyl pyridine; or
the quencher is 2-benzyolpyridine.

In the formulas herein the term hydrocarbyl is used to refer to a chemical group or moiety that contains only carbon and hydrogen. The hydrocarbyl groups of the quencher must not adversely affect the function of the quencher to coordinate with the activated catalyst metal and to react to tag oligomers and polymers. A hydrocarbyl group or moiety may be a univalent group or a multivalent group. The group may be cyclic, straight-chain, branched or contain portions that are cyclic, straight-chain and/or branched. Hydrocarbyl groups and moieties include saturated alkyl groups, cyclic alkanes, aryl groups (containing one or more aromatic rings) and unsaturated hydrocarbon groups that do not affect the function of the quencher. Preferred hydrocarbyl groups that are alkanes are those having from one to about 20 carbon atoms. Alkane groups include those having one to six carbon atoms, and those having one to ten carbon atoms. Aryl groups can contain two or more aromatic rings which may be fused aromatic rings. Hydrocarbyl aryl groups have carbocyclic aromatic rings (all C). Aryl groups include those having six to 20 carbon atoms and those having six to twelve carbon atoms.

Hydrocarbyl groups of the quencher are optionally substituted, in general, with one or more functional groups that do not adversely affect the functions of the quencher. Optional substituents include, among others, halogens (e.g., F, Cl, Br), —CO or —COO— groups, —NO₂, —CN, —N(R′)₂ or —CO—N(R′)₂ where R′ is H or a hydrocarbyl group. Substituents also include groups which can replace one or more —CH—, or —CH₂— moieties in a hydrocarbyl group, such as the replacement of one or more non-neighboring —CH— or —CH₂— moieties with —O—, —CO—, —COO—, —S—, —NR′— or —CO—NR′— moieties. Substituted aryl groups may contain one or more heterocyclic aromatic rings.

A specific implementation of the invention is illustrated below for the quencher DCC.

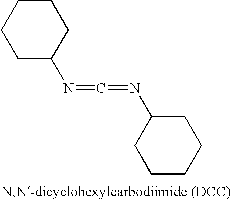

Upon quenching, a C-alkyl amidate ligand is formed, which upon acidic workup is protonated to the amidine. Because of its high basicity, the amidine is easily protonated and electrosprayed as the amidinium ion in positive-ion mode. The amidine solutions are air- and water-stable, and can be stored indefinitely under normal conditions, which greatly eases the practical aspects of their analysis.

Suitable quenchers also include substituted olefins such as 4-Dimethylamino-1-butene and 2-benzoylpyridine.

The quenching reaction to form tagged polymer chains is represented by the following process illustrated for DCC:

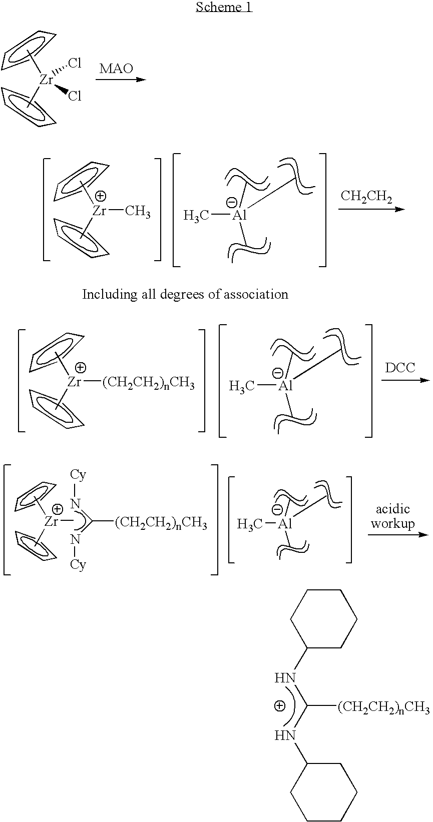

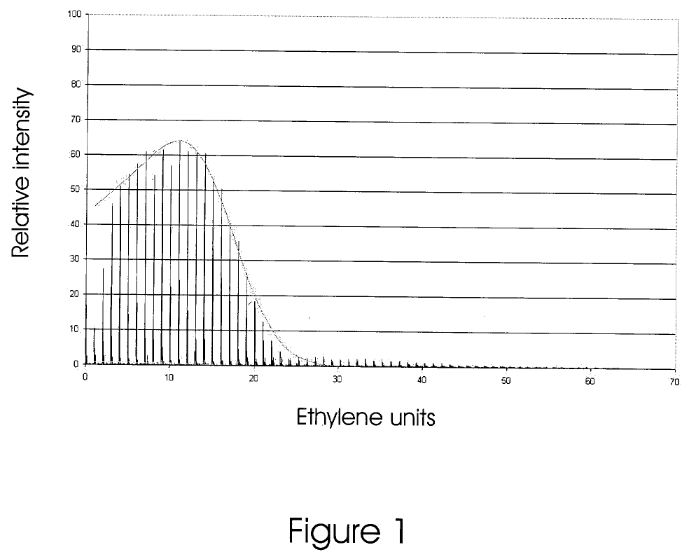

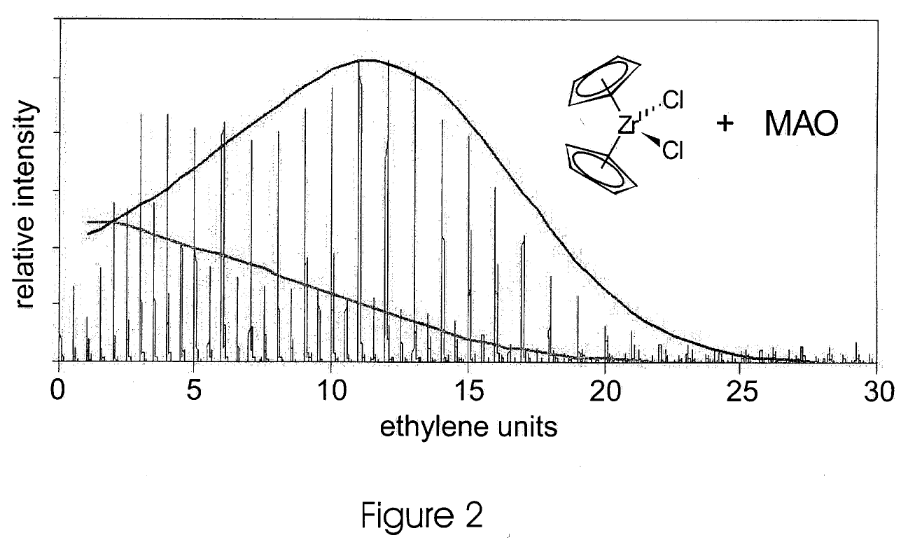

The electrospray ionization mass spectrum of the amidines produced in a typical experiment is shown in FIG. 1, with a fit to the oligomer distribution. FIG. 2 shows an ESI-MS of a DCC-quenched polymerization of ethylene by MAO activated Cp₂ZrCl₂ after acidic workup. The odd- and even-chain distributions are clearly seen. The odd chains represent oligomers which have not yet undergone chain transfer. The even chains have undergone chain transfer at least once.

Extraction of the rates from the spectrum by means of a fit to the kinetic scheme was described previously (See PCT application IB/00/00062, PCT Publication WO 00/43771 and U.S. patent application Ser. No. 09/489,863, filed January 24, 20). Mass spectra, such as FIG. 2, show catalyst-bound oligomer chains with either an even or odd number of carbons in the chain—these are oligomers that have either have or have not undergone chain transfer. By fitting the oligomer distributions with the differential equations representing the mechanism of the polymerization, unique values for the initiation, propagation, and chain-transfer are obtained. The characteristic shape of the distributions depends on the rates chosen for each of the elementary processes: propagation, and chain transfer. Furthermore, each of the elementary rates depend on temperature and, according to the mechanism, also (parametrically) on other process such as pressure. Quantitative values can be obtained by fitting. By varying the temperature, one obtains Arrhenius parameters from the rates.

More importantly, the measured rates from the fit, or alternatively from the Arrhenius parameters, can be reintroduced into the differential equations describing the mechanism, and then used to compute the rate of olefin uptake and the molecular weight of the polymer. Use of these rates to compute the polymer weight-average molecular weight proceeds as previously described (See PCT application IB/00/00062, WO publication 00/43771 and U.S. patent application Ser. No. 09/489,863, filed January 24, 20). Arrhenius analysis of kinetic parameters of a finite number of temperatures can be used to predict polymer properties at a variety of temperatures.

The methods of this invention represent an improvement over the prior art because the use of the coordinating and reactive quencher provided information not previously readily available. Specifically, for use of the carbodiimide quenchers conversion of labile metal alkyls into the corresponding alkyl amidines makes possible treatment of a much wider range of polymerization catalysts than had been practical.

The present invention allows for the first time the treatment of heterogeneous or heterogenized single-site catalysts because the quenchers of this reaction are capable of cleaving the oligomer chains off of the catalyst while preserving the identity of those chains.

The methods of this invention have been shown to allow a comparison of the catalyst-bound oligomer distribution for a homogeneous catalyst and for the supported catalyst. For example, tagged oligomers generated by a MAO-activated, SiO₂-supported CP₂ZrCl₂ catalyst can be compared with those generated on quenching of the homogeneous catalyst. The homogeneous catalyst and the supported catalyst showed some differences, particularly in the extent of chain transfer. The quantification of the effect of the support on elementary reaction rates is a key step to predicting catalyst performance.

The present invention facilitates the rapid quantitation of activation efficiency for olefin polymerization catalysts, particularly single-site catalysts, as a function of process conditions, e.g. temperature, as well as molar excess of the activator, usually MAO. Taking as a mechanistic model for MAO activation the following 4-state picture, 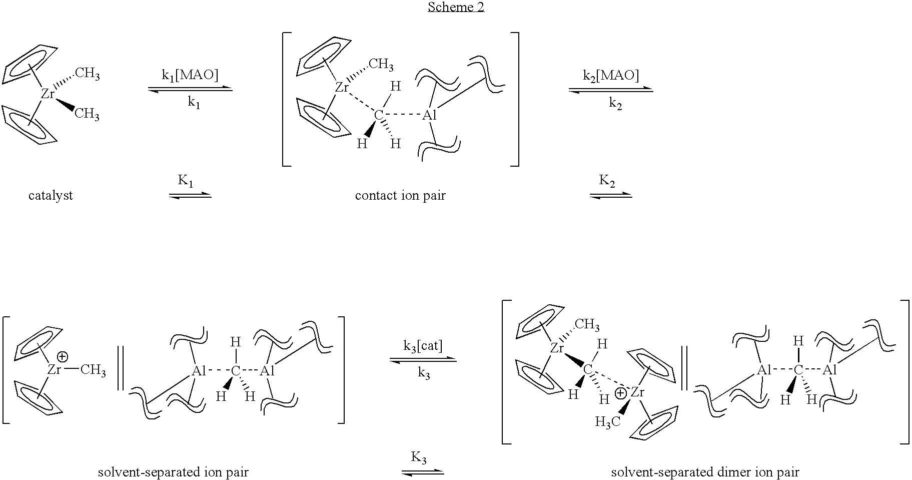
one can define activation as the formation of all ion pairs taken together. Each quencher molecule corresponds to a single activated catalyst molecule, so the calibration of the integrated peak intensity of all of the tagged oligomers or polymers in the mass spectrum against a known concentration of a cationic reference substance delivers the concentration of activated catalyst molecules. While many cationic reference substances are possible in principle, particularly suitable are cationic laser dyes, such as Rhodamine 6G.

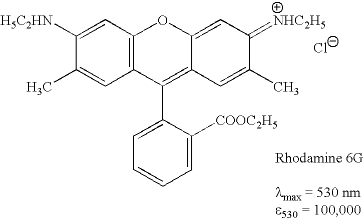

These dyes dissolve in polar and nonpolar organic solvents. They give intense peaks in the electrospray mass spectrum, for which the peak intensity is linear in concentration over a broad range of concentrations. Moreover, the intense optical absorption in the visible means that an after-the-fact calibration of the reference concentration can be done by UV-VIS spectroscopy.

Quantitation of activation efficiency can also be preformed by reacting a quencher with an activated catalyst to transfer a functional group to the quencher as illustrated by the reaction of a substituted olefin with an activated Cp₂ZrCl₂ catalyst in Scheme 3. Scheme 3 shows the transfer of a methyl group from the activated catalyst to the olefin substituted with group X. The relative amounts of methyl groups transferred to the quencher can be measured and compared to the amounts of unreacted quencher.

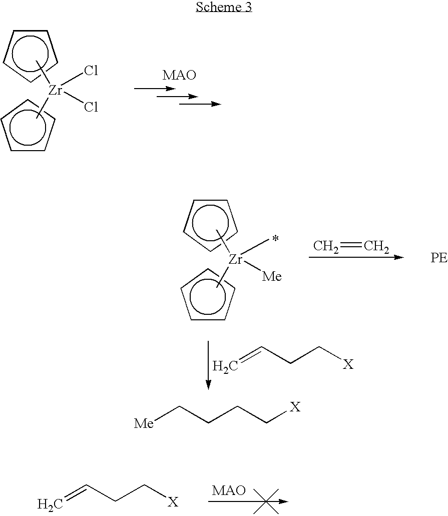

It should be emphasized that the present invention differs from prior art applications of mass spectrometry to the study of polymerization reactions in that the desired property or properties measured—a polymer molecular weight distribution, for example,—is not measured by mass spectrometry of the actual polymer product. In a specific embodiment, a special subset of all oligomer/polymer chains—those that were bound to the metal center at the time of quenching—is measured, and it is from this data that the desired polymer property is then computed using a kinetic model. Also, compared to the prior art, the present invention solves a particular technical problem. Because a single catalyst molecule processes multiple substrate molecules, undergoing up to 10⁶ turnovers for a good SSC catalyst, metal-free or unbound oligomer and polymer chains are present in much higher concentration than the catalyst. Nevertheless, the kinetic analysis cannot be performed on the free chains, and a direct measurement of polymer chain distributions requires that the reaction be run to completion rather than quenched at short time. The present invention provides a method by which only the metal-bound oligomer and/or polymer chains may be chemically modified in such a way as to allow the very small concentration of these chains to be distinguished from the much more prevalent metal-free ones. Previously available methods for investigation of polymerization do not allow such information to be obtained at short reaction times. Accordingly, the kinetic analysis employing data gathered for metal-bound oligomers and polymers at short quench times and its concomitant advantages cannot be performed using methods in the prior art.

### EXAMPLES

### Example 1

### Reaction and Quenching of Cp₂ZrCl₂/MAO with DCC

In a glove-box, bis(cyclopentadienyl)zirconium dichloride (dichlorozirconocene) (8.2 mg, 2.8×10⁻⁵ mol) was weighed into a dry pressure tube equipped with a stirring bar (5 cm). The catalyst was then dissolved in dry toluene (15 ml, distilled from Na) and MAO (10% w/w in toluene, 170 μl, 2.8×10⁻⁴ mol) was added to the clear solution. The pressure tube was then closed and removed from the dry-box, then warmed or cooled to the appropriate temperature (0° C., 20° C., 40° C., 60° C.) and then pressurized with ethylene to the desired pressure (typically 4 bar). The reaction was then stirred vigorously at the indicated temperature for 5 minutes. After this time, the ethylene pressure was carefully released and a solution of 1,3-dicyclohexylcarbodiimide (DCC, 578 mg, 2.8×10⁻³ mol in 4 ml toluene) was added. An aliquot of the suspension (typically 5 ml) was then filtered and diluted with an equal volume of dichloromethane or acetonitrile. This solution was subjected to ESI-MS-analysis.

The quenched species, in principle, zirconocenium amidate cations, may be detectable as such or treated by acidic workup and detected as the protonated amidine. FIG. 2 is an ESI-MS of a DCC-quenched polymerization of ethylene by MAO activated Cp₂ZrCl₂ after acidic workup. The odd- and even-chain distributions are clearly seen.

### Example 2

### Reaction and Quenching of rac-ethylenebis(indenyl)zirconium Dichloride ((EBI)ZrCl₂)/MAO with DCC

In the glove-box, (EBI)ZrCl₂ (11.7 mg, 2.8×10⁻⁵ mol) was weighed into a dry pressure tube equipped with a stirring bar (5 cm). The catalyst was then dissolved in dry toluene (15 ml, distilled from Na) and MAO (10% w/w in toluene, 170 μl, 2.8×10⁻⁴ mol) was added to the clear solution. The pressure tube was then closed and removed from the dry-box. It was then warmed or cooled to the appropriate temperature (−20° C., 20° C., 30° C.) and then pressurized with ethylene to the desired pressure (typically 4 bar). The reaction was then stirred vigorously at the indicated temperature for 5 minutes. After this time, the ethylene pressure was carefully released and a solution of 1,3-dicyclohexylcarbo-diimide (DCC, 578 mg, 2.8×10⁻³ mol in 4 ml toluene) was added. An aliquot of the quenched suspension (typically 5 ml) was then filtered and diluted with an equal volume of dichloromethane or acetonitrile. This solution was subjected to ESI-MS-analysis.

### Example 3

### Reaction and Quenching of bis(cyclopentadienyl)zirconium Dichloride (Cp₂ZrCl₂) Supported on SiO₂

In the glove-box, CP₂ZrCl₂ on silica-gel (3% w/w, 585 mg, 6.0×10⁻⁵ mol) was weighed into a dry pressure tube equipped with a stirring bar (5 cm). The catalyst was then dissolved in dry toluene (25 ml, distilled from Na) and MAO (10% w/w in toluene, 364 μl, 6.0×10⁻⁴ mol) was added to the clear solution. The pressure tube was then closed and removed from the dry-box. The temperature of the tube was then adjusted to 20° C., and it was then pressurized with ethylene to the desired pressure (4 bar). The reaction was then stirred vigorously for 5 minutes. After this time, the ethylene pressure was carefully released and a solution of 1,3-dicyclohexylcarbodiimide (DCC, 1237 mg, 6.0×10⁻³ mol in 4 ml toluene) was added. An aliquot of the quenched suspension (5 ml) was then filtered and diluted with an equal volume of acetonitrile. This solution was subjected to ESI-MS-analysis.

### Example 4

### Quantification of Activation for (Cp₂ZrCl₂)/MAO

In the glove-box, CP₂ZrCl₂ (17.5 mg, 6×10⁻⁵ mol) was weighed into a dry pressure tube equipped with a stirring bar (5 cm). The catalyst was then dissolved in dry toluene (20 ml, distilled from Na). The pressure tube was then closed, removed from the dry-box and was attached to the pressure apparatus. The solution was then pressurized to 4 bar and cooled to −20° C. with a salt-ice bath for 30 minutes. The pressure was then released and the selected amount of MAO was added to the clear solution (MAO10% w/w in toluene exemplary amounts: 364 μl, (6×10⁻⁴ mol, 10 equiv.), 628 μl, (1.2×10⁻³ mol, 20 equiv.), 1.82 ml, (3×10⁻³ mol, 50 equiv.), 2.55 ml, (4.2×10⁻³ mol, 70 equiv.) The ethylene pressure was reestablished at 4 bar and the reaction was stirred vigorously for 5 minutes at −20° C. After this time, the ethylene pressure was carefully released and a five-fold excess of 1,3-dicyclohexylcarbodiimide with respect to MAO was added to each sample (360 mg, (3×10⁻³ mol), 720 mg, (6×10⁻³ mol), 1.8 g, (1.2×10⁻² mol), 2.52 g, (2.1×10⁻² mol), in 4 ml toluene). An aliquot of the quenched suspension for each sample (typically 5 ml) was then filtered and diluted with an equal volume of a 10⁻⁵ M solution of Rhodamine 6G in acetonitrile. Each sample was subjected to ESI-MS-analysis.

### Example 5

### Reaction and Quenching of CP₂ZrCl₂/MAO with 2-benzoylpyridine

In a glove-box, bis(cyclopentadienyl)zirconium dichloride (8.8 mg, 3×10⁻⁵ mol) was weighed into a dry pressure tube equipped with a stirring bar (5 cm). The catalyst was then dissolved in dry toluene (10 ml, distilled from Na) and MAO (10% w/w in toluene, 170 μl, 3×10⁻⁴ mol) was added to the clear solution. The pressure tube was then closed, removed from the dry-box, and pressurized with ethylene to 4 bar. The reaction was then stirred vigorously at room temperature for 5 minutes. After this time, the ethylene pressure was carefully released and a solution of 2-benzoylpyridine (550 mg, 3×10⁻³ mol in 2 ml toluene) was added. An aliquot of the quenched suspension (5 ml) was then filtered and diluted with an equal volume of acetonitrile. This solution was subjected to ESI-MS-analysis.

### Example 6

### Reaction and Quenching of Cp₂ZrMe₂/BArF with DCC

In the glove-box, bis(cyclopentadienyl)dimethylzirconium (7.5 mg, 3×10⁻⁵ mol) was weighed into a dry pressure tube equipped with a stirring bar (5 cm). The catalyst was then dissolved in dry toluene (10 ml, distilled from Na) and tris(pentafluorphenyl)borane (0.044 M in toluene, 750 μl, 3.3×10⁻⁵ mol) was added to the clear solution. The pressure tube was then closed and removed from the dry-box, and pressurized with ethylene to 4 bar. The reaction was then stirred vigorously at room temperature for 5 minutes. After this time, the ethylene pressure was carefully released and a solution of DCC (620 mg, 3×10⁻³ mol in 2 ml toluene) was added. An aliquot of the quenched suspension (5 ml) was then filtered and diluted with an equal volume of acetonitrile. This solution was subjected to ESI-MS-analysis.

### Example 7

### Reaction and Quenching of (salicylaldimine)₂Ni/MeLi with Benzoylpyridine

In a dry-box, (salicylaldimine)₂Ni(19 mg, 22 μmol) was weighed in a dry pressure tube equipped with a stirring bar (5 cm) and dry toluene (10 ml) was added. The tube was closed, removed from the dry-box and attached to the pressure apparatus. Methyllithium (53 μmol, 1.2 eq/Ni, 300 μl, 0.175 M) was added and the reaction was pressurized with ethylene (4 bar). After 5 minutes at room temperature, the pressure was released, the tube was closed and brought into a glove-box. Benzoylpyridine (3 crystals, ≈10 mg) was then added and the reaction mixture was stirred vigorously. After a few minutes, three drops of this solution was diluted with dry acetonitrile and the resulting suspension was filtered. This filtrate was subjected to ESI-MS analysis.

### Example 8

### Reaction and Quenching of a MAO-Activated Fe-Based Catalyst with DCC

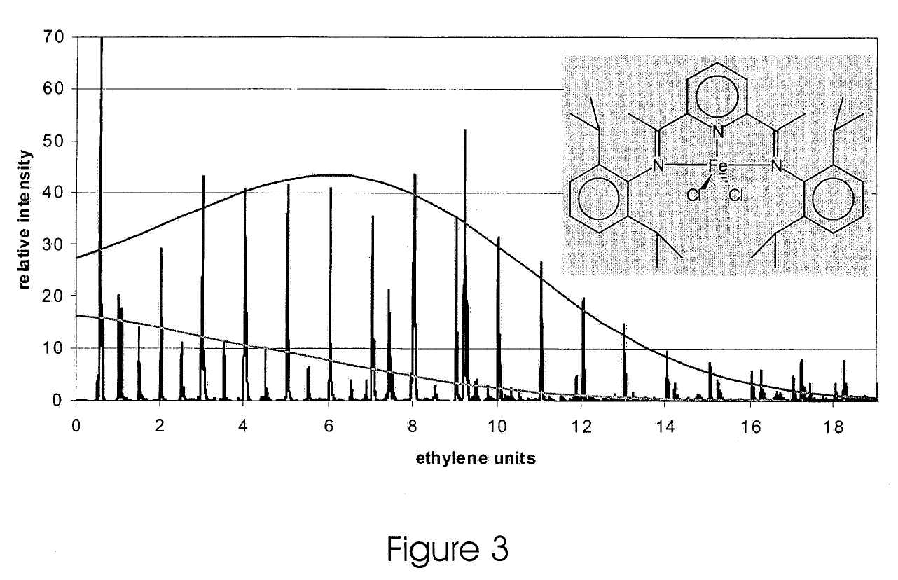

FIG. 3 shows the ESI-MS of a DCC quenched polymerization of ethylene by a MAO-activated Fe-based catalyst after acidic workup. The odd- and even-chain distributions are clearly seen.

### Example 9

### Quantification of MAO-Activated Zr-Based Catalysts with a 4-dimethylamino-1-butene Quencher

Sample preparation and reactions were performed under argon in a glove box or with Schlenk techniques. Toluene was freshly distilled from sodium. 4-Dimethylamino-1-butene as a 0.12 M solution in toluene was dried over CaH₂ and then separated from the solid (drying agent) by trap-to-trap distillation. Electrospray ionization mass spectrometry was performed with a Thermo Finnigan TSQ Quantum mass spectrometer using a flow rate of 5-10 μL/min and a spray voltage of 3-5 kV under nitrogen gas. The conditions were optimized for each measurement.

The Zr catalyst (˜0.017 mmol) was dissolved in dry toluene (the amount is dependent on the given amount of MAO, the total reaction volume was 10.0 mL) and then treated with MAO (1.7M in toluene, 5-1000 equivalents).

The colored solution was stirred under argon for 20 minutes at room temperature. The 4-Dimethylamino-1-butene quencher (0.124 M in toluene, 1 equivalent) was then added; the decolorized solution was then stirred for another minute. The entire reaction solution was then poured into water and stirred for 10 minutes. Five drops acetic acid and 10 mL methanol were then added to the mixture which was then evaporated to dryness in a rotary evaporator. The residue was treated with 0.5 mL methanol and two drops acetic acid, filtered and then analyzed by mass spectrometry.

In certain cases there can be problems at the stage where the residue is extracted due to coextraction of aluminum-containing residues by the acidified methanol. The extraction can be performed with neutral or basic solvent mixtures or with apolar solvents which would subsequently be acidified.

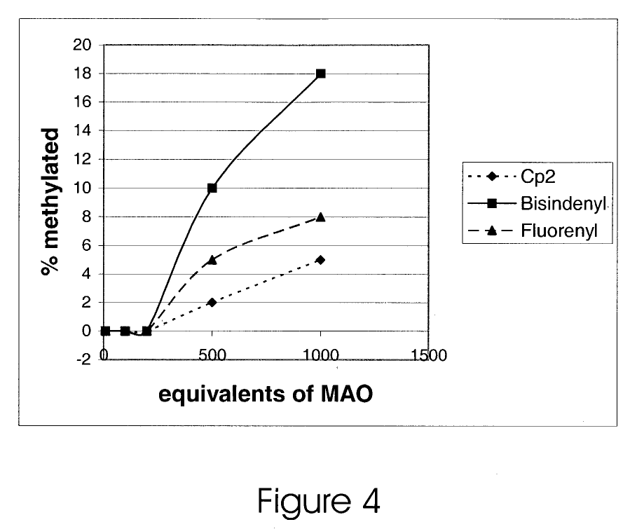

To quantify the amount of active metallocene catalyst, the amount of transferred methyl groups to an appropriate quencher was measured and compared to the amount of unreacted quencher left. The relative amounts of reacted and unreacted quencher were determined using electrospray ionization mass spectrometry. FIG. 4 shows the percentage of methylated quencher molecules as a function of the number of equivalents of MAO for the three different metallocene catalysts shown below.

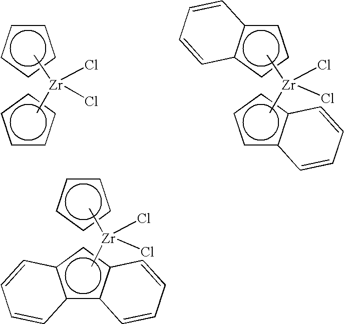

It was found that 4-Dimethylamino-1-butene does not react with MAO (1000 equivalents, 24 hours). In experiments conducted in the presence of polymerizable olefins, it was found that addition of 4-Dimethylamino-1-butene quenched polymerization reactions immediately upon addition and that 4-Dimethylamino-1-butene was incorporated into the polymer extremely slowly (days).

Those of ordinary skill in the art will appreciate that materials and methods other than those specifically disclosed herein can be employed in the practice of this invention without expense of undue experimentation. Functional equivalents of methods and materials specifically disclosed herein that are known in the art and/or which would be readily apparent to one of ordinary skill in the art are encompassed by this invention. All references cited herein are incorporated herein in their entirety by reference.

1. A method for assessing the performance of a test olefin polymerization catalyst which comprises one or more metals which comprises the steps of:
(a) contacting the activated test polymerization catalyst with one or more polymerizable olefins under a selected set of reaction conditions for a selected reaction time;
(b) quenching the polymerization reaction at that selected reaction time with a coordinating-reactive quencher reagent which generates tagged oligomers and optionally tagged polymers on quenching wherein the oligomers and any polymers that are tagged are those oligomers and polymers that at the time of quenching were bound to the catalyst;
(c) detecting any tagged oligomers and tagged polymers generated on quenching; and (d) assessing the performance of the activated test polymerization catalyst based on the tagged oligomers and tagged polymers detected.

2. The method of claim 1 wherein the molecular weights of any tagged oligomers and tagged polymers generated on quenching are determined.

3. The method of claim 2 wherein the molecular weights of any tagged oligomers and tagged polymers are used to calculate one or more kinetic parameters of the polymerization reaction of the test polymerization catalyst with the one or more olefins.

4. The method of claim 3 wherein the one or more kinetic parameters calculated are one or more reaction rates.

5. The method of claim 4 wherein one or more of the rates of initiation, propagation and chain-transfer are calculated.

6. The method of claim 1 wherein detection of tagged oligomers and tagged polymers indicates that the test polymerization catalyst is active for polymerization of the one or more olefins.

7. The method of claim 1 wherein performance of the test catalyst is assessed by determining the length of any tagged oligomers and tagged polymers formed on quenching.

8. The method of claim 1 wherein the relative amounts of tagged oligomers and tagged polymers in a sample is determined to obtain a distribution of tagged products.

9. The method of claim 1 further comprising a step of adding a known amount of an internal standard to a sample and wherein the absolute amounts of one or more of any tagged oligomers and one or more of any tagged polymers in a sample is determined.

10. The method of claim 9 wherein the internal standard is a cationic dye.

11. The method of claim 10 wherein the internal standard is Rhodamine 6G.

12. The method of claim 9 wherein the amount of internal standard added to the sample is determined using a method other than mass spectrometry.

13. The method of claim 12 wherein the amount of internal standard added to the sample is determined by visible or UV spectroscopy.

14. The method of claim 1 wherein the test polymerization catalyst is an organometallic complex.

15. The method of claim 1 wherein the test polymerization catalyst is known to be active for olefin polymerization.

16. The method of claim 1 wherein the test polymerization catalyst is a metallocene.

17. The method of claim 1 wherein the test polymerization catalyst is a single-site catalyst.

18. The method of claim 17 wherein the single-site catalyst is a metallocene.

19. The method of claim 17 wherein the single-site catalyst is a non-metallocene.

20. The method of claim 1 wherein the polymerization catalyst is a homogeneous catalyst.

21. The method of claim 1 wherein the test polymerization catalyst is a supported catalyst.

22. The method of claim 1 wherein the detection of tagged oligomers and tagged polymers generated on quenching is used to assess the effect of the catalyst support upon catalyst performance.

23. The method of claim 1 wherein the activated polymerization catalyst is generated by addition of one or more activators to the polymerization catalyst.

24. The method of claim 23 wherein efficiency of activation of a selected activator is assessed by detection of tagged oligomers and tagged polymers formed on quenching.

25. The method of claim 23 wherein the activator is an alkyl aluminum compound.

26. The method of claim 23 wherein the activator is a borane or borate.

27. The method of claim 23 wherein the activator is methylalumoxane (MAO) or a modified form thereof.

28. The method of claim 1 in which the tagged oligomers and tagged polymers are analyzed by mass spectrometry.

29. The method of claim 1 wherein the tagged oligomers and tagged polymers are analyzed by electrospray ionization mass spectrometry.

30. The method of claim 1 wherein the quencher is a molecule having the formula:
(Rx)ₐ—X═C═Y—(Ry)_{b}
and salts thereof where X and Y, independently of one another, are N, O or S atoms, Rx and Ry, independent of each other and of other Rx and Ry in the molecule, are one or more optionally substituted hydrocarbyl groups, and any two or more Rx or Ry can be linked together to form a cyclic moiety, a and b are zero, 1 or 2 and represent the number of Rx or Ry groups present to satisfy valency of X or Y and either or both of X and Y can carry a positive or negative charge.

31. The method of claim 30 wherein X and Y are N.

32. The method of claim 23 wherein both of Rx and Ry are optionally substituted alkyl groups.

33. The method of claim 32 wherein one or both of Rx and Ry are cyclohexyl groups.

34. The method of claim 1 wherein the quencher is a molecule having the formula:
(Rx)ₐX—CR¹═CR²—Y(Ry)_{b}
or salts thereof where X and Y, independently of one another, are N, O or S atoms, Rx and Ry, independent of each other and of other Rx and Ry in the molecule, are one or more optionally substituted hydrocarbyl groups and any two Rx or Ry groups can be linked together to for a cyclic moiety, a and b are zero, 1 or 2 representing the number of Rx or Ry groups present to satisfy valency of X or Y one or both of which may carry a positive or negative charge and R¹ and R², independent of each other, are H or an optionally substituted hydrocarbyl group.

35. The method of claim 34 wherein X is N and Y is O.

36. The method of claim 35 wherein Y is O and R² is an optionally substituted aryl group.

37. The method of claim 34 wherein Y is O and R² is an optionally substituted aryl group.

38. The method of claim 37 wherein X is N and Rx and R¹ together form an optionally substituted aryl group.

39. The method of claim 1 wherein the quencher is a carbodiimide.

40. The method of claim 39 wherein the carboidiimide is DCC.

41. The method of claim 1 wherein the quencher is an optionally substituted 2-benzoyl pyridine.

42. The method of claim 41 wherein the quencher is 2-benzyolpyridine.

43. The method of claim 1 wherein the quencher is selected from the group consisting of heterocumulenes, allenes, carbonyl compounds with no proton on the α-carbon and having a metal-coordinating group linked to the carbonyl group, enamines, enolethers, enolesters and unsaturated phosphonium salts.

44. A method for screening a library of test olefin polymerization catalysts containing at least one metal element which comprises evaluating each of the test catalysts by the method of claim 1.

45. A method for quantification of the amount of active species of a metal-containing catalyst comprising the steps of:
(a) activating the metal-containing catalyst with an activator;
(b) reacting the activated catalyst with a coordinating-reacting quencher reagent;
(c) detecting the reacted quencher reagent and any unreacted quencher reagent; and
(d) quantifying the amount of active species of the catalyst by comparing the amount of reacted quencher reagent to the amount of unreacted quencher reagent.

46. The method of claim 1 wherein the quencher is 4-Dimethylamino-1-butene.
